(19) United States
(12) Patent Application Publication
(10) Pub. No.: US 2026/0192250 A1
(43) Pub. Date: Jul. 9, 2026

(54) METHOD AND APPARATUS FOR TREATING DIESEL EXHAUST EMISSIONS

(71) Applicant: CJ Reactor Pty Ltd, Subiaco (AU)

(72) Inventor: Terrence Reid, Bibra Lake (AU)

(21) Appl. No.: 19/496,231

(22) PCT Filed: Jun. 25, 2024
(86) PCT No.: PCT/AU2024/050666

§ 371 Date: Dec. 22, 2025

(30) Foreign Application Priority Data
Jun. 29, 2023 (AU) 2023902073
Dec. 4, 2023 (AU) 2023903918

(51) Int. Cl. B01D 53/92; B01D 45/16; B01D 51/10; B01D 53/62; F01N 3/20; F01N 3/28; F01N 3/30

(52) U.S. Cl. CPC B01D 53/92; B01D 45/16; B01D 51/10; B01D 53/62; F01N 3/2066; F01N 3/2892; F01N 3/30; B01D 2251/2062; B01D 2257/504; B01D 2258/012; F01N 2610/02; F01N 2610/1406; F01N 2610/1453

(57) ABSTRACT

Apparatus for treating diesel exhaust emissions. The apparatus includes an intake manifold having a diesel exhaust outlet and an inlet for ingress of an ammonia gas stream wherein the ammonia gas stream mixes with the diesel exhaust to produce a gas mixture. The apparatus includes a conditioning chamber that passes the gas mixture to a first gas-liquid contact zone where it reacts with a stream of aqueous ammonia solution to produce a gas-liquid mixture. The apparatus further includes a static mixer in fluid communication with the first gas-liquid contact zone, and interposed between the first gas-liquid contact zone and a second gas-liquid contact zone. The second gas-liquid contact zone has a spray head to spray a stream of aqueous ammonia solution therein and an impellor to induce turbulence in the second gas-liquid contact zone. The gas-liquid mixture in the second gas-liquid contact zone separates by gravity.

### CROSS-REFERENCE TO RELATED APPLICATIONS

The present application is a U.S. National Stage patent application of International Patent Application No. PCT/AU2024/050666, filed Jun. 25, 2024, which claims the benefit of Australian Patent Application No. 2023903918, filed Dec. 4, 2023 and Australian Patent Application No. 2023902073, filed Jun. 29, 2023, the benefit of which is claimed and the disclosures of which are incorporated herein by reference in their entirety.

### TECHNICAL FIELD

The disclosure relates to a method and apparatus for treating diesel exhaust emissions, in particular a method and onboard apparatus for treating diesel exhaust emissions from vehicles.

### BACKGROUND

The discussion of the background to the disclosure is intended to facilitate an understanding of the disclosure. However, it should be appreciated that the discussion is not an acknowledgement or admission that any of the material referred to was published, known or part of the common general knowledge as at the priority date of the application.

The transportation sector, is a major contributor to CO₂ emissions. In particular, heavy vehicles, rail and marine transport are reliant on diesel fuel. The composition of diesel exhaust emissions are about 12% CO₂ and 1% pollutants such as CO, nitrous oxides (NOₓ), sulphur oxides (SOₓ) and particulates.

Electrification of vehicles is one option to reduce CO₂ emissions. However, adoption of battery technology is disadvantaged by increased payload weight (in comparison with hydrocarbon fuel) and prolonged charging times.

There is a need to integrate onboard apparatus to treat exhaust emissions by capturing CO₂ and converting NOₓ and SOₓ to useful byproducts.

Amine absorption, membrane separation, cryogenic separation and adsorption are well understood technologies for treatment of flue gases to remove pollutants, such as particulates, heavy metal compounds, NOₓ and SOₓ to comply with regulations for environmental control. Absorbents and membranes, however, require regular regeneration which has an energy cost associated therewith. Solvent absorbents such as monoethanolamine (MEA) and other primary amines, in particular are subject to corrosion and solvent degradation over time.

The present disclosure provides a method and apparatus for treating diesel exhaust emissions to overcome at least some of the disadvantages discussed above, with the additional potential to manufacture saleable byproducts.

### SUMMARY

The disclosure provides a method and apparatus for treating diesel exhaust emissions, in particular a method and onboard apparatus for treating diesel exhaust emissions from vehicles.

In one aspect the disclosure provides a method of treating diesel exhaust emissions, the method comprising:
a) contacting an ammonia gas stream with a diesel exhaust emissions stream to produce a gas mixture, and passing the gas mixture to a first reactor arranged to perform the following steps:
b) conditioning the gas mixture;
c) contacting the conditioned gas mixture with a first stream of aqueous ammonia solution in a first gas-liquid contact zone to produce a gas-liquid mixture;
d) passing the gas-liquid mixture through a static mixer; and
e) contacting the gas-liquid mixture from step d) with a second stream of aqueous ammonia solution in a second gas-liquid contact zone.

In one embodiment, the method further comprises:
f) separating the resulting mixture from step e) by gravity, collecting liquid from said mixture in a launder reservoir and venting a carbon dioxide-depleted gas mixture.

In one embodiment, the method comprises circulating the carbon dioxide-depleted gas mixture to a second reactor and repeating steps b) to e) prior to venting said gas mixture.

In one embodiment, prior to step e), the method comprises agitating the gas-liquid mixture after it has passed through the static mixer.

In one embodiment the launder reservoir contains aqueous ammonia solution.

In one embodiment, the method further comprises circulating first and second aqueous ammonia solutions, respectively, from the launder reservoir to the first and second gas-liquid contact zones of the first reactor.

In one embodiment, the contents of the launder reservoir are maintained below 38° C.

In one embodiment, conditioning the gas mixture comprises inducing high energy flow in the gas mixture and passing the gas mixture through a cyclone chamber in the first reactor in an arrangement to increase gas-solid collisions and deplete the gas mixture of one or more of particulate material, NOₓ and SOₓ.

In one embodiment, passing said first stream through the static mixer increases the pressure of said first stream to 55-60 psi.

In one embodiment, the diesel exhaust emissions stream is passed through a heat exchanger before contacting said stream with the ammonia gas stream.

In another aspect the disclosure provides an apparatus for treating diesel exhaust emissions, the apparatus comprising:
a launder reservoir containing aqueous ammonia solution;
an intake manifold in fluid communication with a diesel engine exhaust outlet, wherein the intake manifold is provided with an inlet for ingress of an ammonia gas stream in an arrangement whereby, in use, the ammonia gas stream mixes with the diesel exhaust emission to produce a gas mixture;
a conditioning chamber in fluid communication with the intake manifold to receive the gas mixture therefrom, wherein the conditioning chamber is configured to pass the gas mixture to a first gas-liquid contact zone whereby the gas mixture is reacted with a first stream of aqueous ammonia solution via a first conduit in fluid communication with the launder reservoir and a nozzle, thereby producing a gas-liquid mixture in the first gas-liquid contact zone;
a static mixer in fluid communication with the first gas-liquid contact zone, and interposed between the first gas-liquid contact zone and a second gas-liquid contact zone; the second gas-liquid contact zone being provided with a spray head configured to spray a second stream of aqueous ammonia solution therein and an impellor to induce turbulence in the second gas-liquid contact zone, wherein said second stream is delivered to the spray head via a second conduit arranged in fluid communication with the launder reservoir, whereby in use, the gas-liquid mixture in the second gas-liquid contact zone separates by gravity, separated liquid collecting in the launder reservoir and carbon dioxide-depleted gas mixture being vented therefrom.

In one embodiment, the conditioning chamber comprises a cyclone chamber configured in use to induce high energy flow in the gas mixture.

In one embodiment, the nozzle comprises a jet nozzle or a venturi tube.

In one embodiment, the nozzle may be disposed in concentric alignment with a central longitudinal axis of the cyclone chamber.

In one embodiment, the nozzle is configured to increase the pressure of said first stream to 50-60 psi.

In one embodiment, the second gas-liquid contact zone comprises a cylindrical skirt having a lower end thereof immersed in the launder reservoir.

In one embodiment the spray head may be a plurality of spray heads spaced equidistantly around and proximal to an inner surface the cylindrical skirt.

In one embodiment, the impellor may be disposed in an upper portion of the second gas-liquid contact zone.

In one embodiment, the launder reservoir may be provided with means to scavenge and remove sludge therefrom.

In one embodiment, the launder reservoir is provided with means to vent a head space thereof.

In one embodiment, the apparatus is arranged in fluid communication with a heat exchanger in an arrangement whereby the heat exchanger is disposed between the diesel engine exhaust outlet and the intake manifold of the apparatus.

A further aspect of the disclosure provides a vehicle having a diesel engine with an exhaust outlet coupled to an apparatus as defined above. In one form, the apparatus may be mounted on a trailer in longitudinal alignment with the vehicle.

In another aspect the disclosure provides a method of creating a financial instrument tradable under a greenhouse gas Emissions Trading Scheme (ETS), the method comprising the step of exploiting the method for treating diesel exhaust emissions as defined above.

In one embodiment, the financial instrument comprises one or either a carbon credit, carbon offset or renewable energy certificate.

### BRIEF DESCRIPTION OF DRAWINGS

Notwithstanding any other forms which may fall within the scope of the process as set forth in the Summary, specific embodiments will now be described with reference to the accompanying figures below:

FIG. 1 is a schematic representation of an apparatus for treating diesel exhaust emissions in accordance with one embodiment of the disclosure;

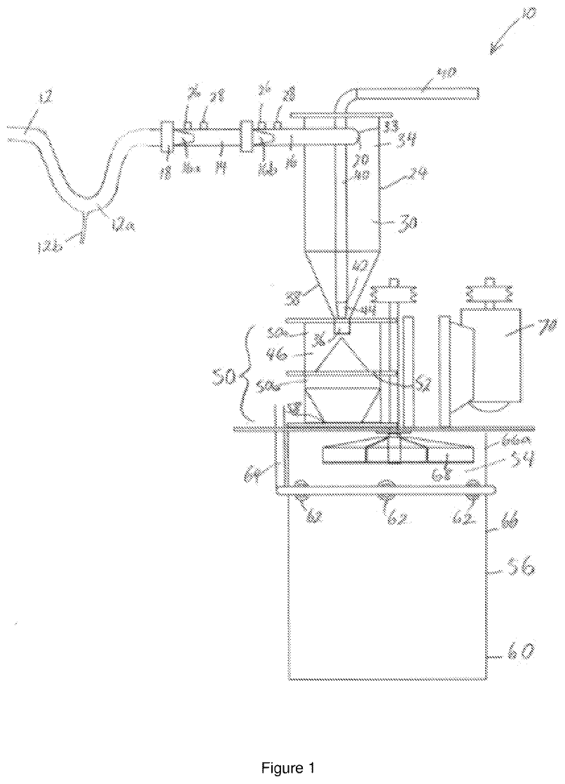

FIG. 2 is a schematic representation of the apparatus for treating diesel exhaust emissions in accordance with another embodiment of the disclosure;

FIG. 3 is a schematic representation of one embodiment of said apparatus mounted on a trailer coupled in longitudinal alignment with an agricultural vehicle;

FIG. 4 is a schematic representation of one embodiment of said apparatus mounted in a consist coupled in longitudinal alignment with a diesel electric locomotive;

FIG. 5 is a schematic representation of one embodiment of said apparatus configured to treat diesel engine emissions from a marine vessel; and

FIG. 6 is a schematic representation of one embodiment of said apparatus mounted on a trailer for treatment of diesel engine emissions from a generator.

### DESCRIPTION OF EMBODIMENTS

The disclosure relates to a method and apparatus for treating diesel exhaust emissions, in particular a method and onboard apparatus for treating diesel exhaust emissions from vehicles.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Reference to positional descriptions, such as lower and upper, are to be taken in context of the embodiments depicted in the figures, and are not to be taken as limiting the invention to the literal interpretation of the term but rather as would be understood by the skilled addressee.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

### Apparatus for Treating Diesel Exhaust Emissions

Referring to the Figures, where like reference numerals are used to denote similar or like parts throughout, there is shown an apparatus 10 for treating diesel engine emissions. Such emissions may be generated by a diesel engine used for various purposes including, but not limited to, electricity generation, marine transport, agricultural and forestry machinery and transport, heavy vehicle transport, rail haulage, mining equipment such as drill rigs, and so forth.

The term “treating diesel exhaust emissions” as used herein refers to a process in which said emissions from a diesel engine are depleted in carbon dioxide, NOₓ, SOₓ and particulates. In other words, the treated diesel exhaust emissions have a lower carbon dioxide, NOₓ, SOₓ and particulates content than the diesel exhaust emissions before treatment.

In use, the apparatus 10 is configured to be in fluid communication with a diesel engine exhaust outlet. It is envisaged that for most applications, it will be impractical to dispose the apparatus 10 immediately adjacent said exhaust outlet. Consequently, the apparatus 10 may be provided with a conduit 12 of suitable length and diameter to convey the diesel engine exhaust emissions from the diesel engine to the apparatus 10 for treatment. The conduit 12 may be flexible or rigid, with one or more joints. It will be appreciated that the conduit 12 may be fabricated from any suitable material and be provided with couplers at respective ends thereof suitably configured to be connected or fastened to the diesel engine exhaust outlet and an intake manifold 14 of the apparatus 10. In some embodiments, the conduit 12 may be provided with a pump to draw said emissions to the apparatus 10.

In some embodiments, the conduit 12 may be arranged in thermal communication with a heat exchanger (not shown) to reduce the temperature of the diesel engine exhaust emissions flowing through the conduit 12 prior to treatment in the apparatus 10. For example, in some embodiments the conduit 12 may pass through a two stage heat exchanger to reduce the temperature of the diesel engine exhaust emissions from about 100° C. to 25° C. to 28° C. Reducing the temperature of the diesel engine exhaust emissions may also be advantageous in that any water vapour in said emissions may partially condense and humidify the diesel engine exhaust emissions. The heat exchanger may be any suitable heat exchanger such as a plate heat exchanger or a shell & tube heat exchanger. Conveniently, in embodiments where the apparatus is deployed on marine vessels, sea water may be used as the heat exchange medium in the heat exchanger.

In some embodiments, the conduit 12 may be provided with a U-bend 12a and a drain 12b disposed at a lowermost end of the U-bend 12a. Advantageously, any liquid water that has condensed in the diesel engine exhaust emission stream after it has passed through the heat exchanger may be collected and drained from the conduit 12 before said emission stream enters the apparatus 10. In this way, the removal of condensed liquid water reduces the emissions load that is subsequently treated by the apparatus 10. It will be appreciated, however, that despite the collection and removal of liquid water said emission stream will remain humidified with water vapour.

The apparatus 10 includes an intake manifold 14 defined by a conduit 16 having an inlet 18 arranged in fluid communication with said conduit 12 and an outlet 20 arranged in fluid communication with an inlet of a first reactor 24. The conduit 16 is also provided with an inlet 26 for ingress of an ammonia gas stream and, optionally, a further inlet 28 for ingress of return vapour, as will be described later. In use, the ammonia gas stream mixes with the diesel exhaust emission within the intake manifold 14 to produce a gas mixture. Carbon dioxide in said emissions reacts with ammonia to produce ammonium bicarbonate and ammonium carbonate in an exothermic reaction.

The conduit 16 may also be provided with one or more venturi tubes 16a, 16b arranged in series. The one or more venturi tubes 16a, 16b induce high energy flow in the diesel engine exhaust emissions and resultant gas mixture prior to passing into a conditioning chamber 30. The high energy flow enhances the exothermic reaction between carbon dioxide and ammonia in the gas mixture, particularly in the presence of water vapour.

The conditioning chamber 30 is arranged in fluid communication with the outlet 20 of intake manifold 14 to receive the gas mixture therefrom. The conditioning chamber 30 may comprise a cyclone chamber configured to further induce high energy flow in the gas mixture. The conditioning chamber 30 has an inlet 33 disposed in an upper cylindrical portion 34 of said chamber 30 and an outlet 36 disposed in a lower conical portion 38 of said chamber 30. The inlet 33 is configured so that, in use, the gas mixture enters the conditioning chamber 30 and flows tangentially about the cylindrical portion 34 and subsequently about the conical portion 38 through outlet 36.

As the gas mixture circulates with high energy flow in the conditioning chamber 30, particulate material, SOₓ and NOₓ compounds entrained in the gas mixture impact a surface of the conditioning chamber 30 at high velocities. Particulate material may adhere to the surface of the conditioning chamber 30, thereby depleting the gas mixture of particulate material. SOₓ and NOₓ compounds may be converted to less harmful compounds, such as ammonium sulphate and ammonium nitrate in the high energy environment of the conditioning chamber 30 due to increased gas-solid collisions.

Reporting gases include N₂O which may be converted to N₂O₃ and N₂O₅ by oxidation caused by high energy impact and gas-solid collisions.

At least a portion of a first conduit 40 is disposed in concentric alignment with a central longitudinal axis of the conditioning chamber 30. A free end 42 of the first conduit 40 may be provided with a nozzle 44 in the form of a jet nozzle or a venturi tube. The nozzle 44 is disposed at or proximal to the outlet 36 of the chamber 30, thereby defining a first gas-liquid contact zone 46 therein.

The first conduit 40 is arranged in fluid communication with a source of aqueous ammonia solution and is provided with fluid delivery means, such as a pump, to deliver a first stream of aqueous ammonia solution at high pressure to the first gas-liquid contact zone 46, thereby producing a gas-liquid mixture. The nozzle 44 may be configured to increase the pressure of said first stream to 50-60 psi. The gas mixture entering the conditioning chamber 30 is drawn down the upper cylindrical portion 34 of said chamber 30 in a tangential flow by the vacuum created by the aqueous ammonia solution being pumped through the first conduit and the nozzle 44.

In some embodiments, the source of aqueous ammonia solution is a launder reservoir 48 containing aqueous ammonia solution. The concentration of the aqueous ammonia solution may be about 5% w/v to about 30% w/v. The ammonia solution may be prepared by sparging water with a source of ammonia, such as ammonia gas, to produce an ammonium hydroxide solution. Alternatively, the ammoniated solution may be prepared by mixing an ammonium hydroxide solution and/or an ammonium bicarbonate/carbonate solution with water. Alternatively, ammoniated solution (28-30%) may be added to the launder reservoir 48 when charging the launder reservoir 48 with water. In use, the launder reservoir 48 is filled to about 60% volumetric capacity with the aqueous ammonia solution.

In use, the pH of the aqueous ammonia solution is maintained in a range of 8.5 to 9.5, preferably pH<9. In this regard, anhydrous ammonia may be added to buffer the aqueous ammonia solution. The aqueous ammonia solution in the launder reservoir 48 may be maintained at a temperature less than 35° C., even less than 30° C. In this way, the partial pressure of carbon dioxide and ammonia are suppressed and these gases are more likely to stay in solution. For example, the launder reservoir 48 may be provided with an immersion heat exchanger to maintain the temperature of the aqueous ammonia solution at less than 35° C. Alternatively, the aqueous ammonia solution may be circulated through an external heat exchanger to maintain the temperature of the aqueous ammonia solution at less than 35° C.

The apparatus 10 includes a static mixer 50 in fluid communication with the first gas-liquid contact zone 46, whereby the static mixer 50 is arranged to receive the gas-liquid mixture produced in the first gas-liquid contact zone 46. The static mixer 50 may be any device configured for continuously mixing fluids in the absence of moving parts. The static mixer 50 may provide flow division or radial mixing of the gas-liquid mixture. In the embodiments shown in the Figures, the static mixer 50 is a plurality of sequentially arranged chambers 50a, 50b which are configured to alternately expand and compress the gas-liquid mixture as it passes therethrough. The chambers 50a, 50b may be provided with a plurality of radial passages 52 through which the gas-liquid mixture passes as it flows through the static mixer 50. Although the static mixer 50 shown in the Figures comprises two sequentially arranged chambers 50a, 50b configured to alternately expand and compress the gas-liquid mixture as it passes therethrough, it will be appreciated that the static mixer 50 may comprise more than two (e.g. x number) chambers 50a, 50b, 50c, . . . 50x to alternately expand and compress the gas-liquid mixture.

The apparatus 10 also includes a second gas-liquid contact zone 54 defined by a draft tube 56 extending from an outlet 58 of the static mixer 50. In use, a lower portion 60 of the draft tube 56 is submerged below a liquid level in the launder reservoir 48. The second gas-liquid contact zone 54 is provided with a spray head 62 configured to spray a second stream of aqueous ammonia solution into the second gas-liquid contact zone 54. The spray head 62 is in fluid communication with the launder reservoir 48 via a second conduit 64 and associated fluid delivery means, such as a pump, to deliver the second stream of aqueous ammonia solution at high pressure to the second gas-liquid contact zone 54.

In the embodiment shown in the Figures, the spray head 62 comprises a plurality of equidistantly spaced spray heads radially disposed about a cylindrical wall 66 of the draft tube 56. It will be appreciated that the spray head 62 may take alternative forms. The spray heads radially disposed about the cylindrical wall 66 of the draft tube 56 are conveniently positioned so that they are directly opposed to one another, thereby maximizing gas-liquid contact in the second gas-liquid contact zone 54.

An impellor 68 driven by a motor 70 is provided in an upper portion 66a of the draft tube 56. The impellor 68 may be spaced apart from and above the spray head 62. The impellor 68 induces turbulence in the gas-liquid mixture, agitating the gas-liquid mixture as it enters the second gas-liquid contact zone 54 and imparting high velocity to the gas-liquid mixture droplets therein. In one example, the impellor 68 may be a spinning disk provided with a plurality of equidistantly spaced radial vanes. The impellor 68 may be operated at 400-1000 rpm by an electric motor (e.g., 1 kW) or an hydraulic motor. The inventor opines that the high velocity gas-liquid mixture droplets may impact the cylindrical wall 66 of the draft tube 56, causing any particulate materials within said droplets to stick thereto. Alternatively, it is envisaged that such particulate materials may be emulsified and collect and float on the liquid level within the draft tube 56. Any emulsified particulate materials may be pumped from the launder reservoir 48, or removed by decanting or skimming.

The floating particulate material may be subsequently separated and removed. For example, the floating particulate material may be removed as a sludge by decanting or by pumping the liquid contents of the launder reservoir 48 and subsequently centrifuging said liquid. In alternative embodiments, a plurality of buoyant bodies 110 may be provided in the launder reservoir 48, whereby the floating particulate material attaches to respective surfaces of the buoyant bodies 110 and the buoyant bodies 110 may then be subsequently removed from the launder reservoir 48. The buoyant bodies may be solid or hollow and may be fabricated from any suitable material including, but not limited to, polystyrene or other lightweight polymeric materials. It will be appreciated that the buoyant bodies may take any suitable form including, but not limited to, spheres or noodles.

The gas-liquid mixture formed in the second gas-liquid contact zone 54 separates under gravity, the liquid collecting in the launder reservoir 48 and the resulting gas mixture remaining in a head space 72 of the draft tube 56. The aqueous ammonia solution in the launder reservoir 48 may be recirculated by pumps through the first and second conduits 40, 64 to the nozzle 44 and the spray head 62 into the first and second gas-liquid contact zones 46, 54 respectively. It will be appreciated that the aqueous ammonia solution in the launder reservoir 48 may become saturated with carbon dioxide after successive recirculation through the apparatus 10.

Accordingly, it is envisaged that the aqueous ammonia solution may be discharged from the launder reservoir 48 when the concentration of ammonium carbonate in the solution become saturated, in particular when the concentration of ammonium carbonate is in the range of 478-480 g/L. The discharged solution may be stored in holding tanks and used as fertilizer, optionally with other fertilizer chemicals. For example, urea could be added to the discharged solution to increase nitrogen content thereof and product a convenient liquid fertilizer.

Carbon dioxide content in the gas mixture is successively depleted by reaction with ammonia in the intake manifold 14, the first gas-liquid contact zone 46 and the second gas-liquid contact zone 54, respectively. The cylindrical wall 54 of the draft tube 56 may include openings, optionally disposed proximal to the spray heads 62, which allow passage of the resulting CO₂-depleted diesel engine emissions into the head space 72 of the launder reservoir 48. The CO₂-depleted diesel engine emissions may then be vented to atmosphere via conduit 74.

It will be appreciated that the CO₂-depleted diesel engine emissions remaining in the head space 72 of the launder reservoir 48 also contains ammonia. These return vapours may be directed via a conduit to inlet 28 of the intake manifold 14 where they may be retreated in the same apparatus 10.

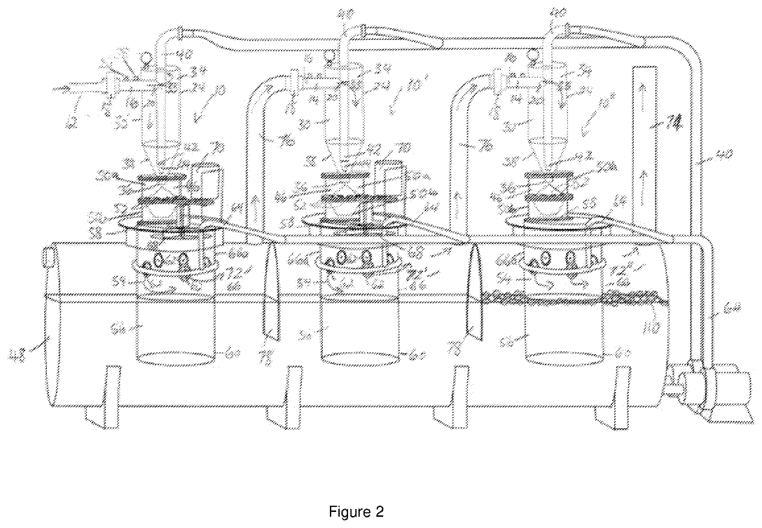

Alternatively, as shown in FIG. 2, the resulting CO₂-depleted diesel engine emissions residing in the head space 72 of the launder reservoir 48 may be passed via conduit 76 to a one or more apparatus 10′, 10″ arranged in series, wherein said apparatus 10′ and 10″ have the same features as described above in respect of said apparatus 10. In this particular embodiment, the series of apparatus 10, 10′, 10″ may be disposed in a single launder reservoir 48. Respective head spaces 72, 72′, 72′″ may be separated and defined by baffles 78 interposed between the apparatus 10, 10′, 10″.

The head space 72 disposed in the launder reservoir 48 may also be provided with spray heads to deliver aqueous ammonia solution sourced from the launder reservoir 48 and react with slipped gases so that they do not accumulate in the launder reservoir head space.

The apparatus 10 as described above is configured to treat emissions from a diesel engine to deplete carbon dioxide, SOₓ and NOₓ gases by successively passing the emissions through a series of reaction zones where the emissions are either reacted with ammonia gas or aqueous ammonia solution. Moreover, the reaction zones are arranged to provide a high energy environment that enhances gas-liquid contact and molecular collisions. Diesel exhaust emissions entering the intake manifold 14 are first mixed with ammonia gas and passed through the one or more venturi tubes 16a, 16b to induce high energy flow in the resultant gas mixture prior to passing said gas mixture into the conditioning chamber 30. The high energy flow enhances the exothermic reaction between carbon dioxide and ammonia in the gas mixture, particularly in the presence of water vapour.

The resultant gas mixture is then passed to the conditioning chamber 30 which is configured to produce tangential flow of the gas mixture about the cylindrical portion 34 and subsequently the conical portion 38 through outlet 36 of the conditioning chamber 30. As the gas mixture circulates with high energy flow in the conditioning chamber 30, particulate material, SOₓ and NOₓ compounds entrained in the gas mixture impact the surface of the conditioning chamber 30 at high velocities. Particulate material may adhere to the surface of the conditioning chamber 30, thereby depleting the gas mixture of particulate material. SOₓ and NOₓ compounds may be converted to less harmful compounds, such as ammonium sulphate and ammonium nitrate in the high energy environment of the conditioning chamber 30 due to increased gas-solid collisions.

The gas mixture then passes into the first gas-liquid contact zone 46 where it is mixed with the first stream of aqueous ammonia solution delivered at high pressure by the nozzle 44. The resulting gas-liquid mixture subsequently passes through the static mixer 50 whereby the gas-liquid mixture is alternately expanded and compressed in the sequentially arranged chambers 50a, 50b of the static mixer 50.

Finally, the gas-liquid mixture passes into the second gas-liquid contact zone 54. The impellor 68 is operated to induce turbulence in the gas-liquid mixture before it is sprayed with the second stream of aqueous ammonium solution by the radially arranged spray heads 62, whereby carbon dioxide entrained in the gas-liquid mixture is further reacted with ammonia to produce ammonium bicarbonate or ammonium hydrogen carbonate. The treated gas-liquid mixture subsequently separates under gravity, whereby the separated liquid falls as droplets into the launder reservoir and the carbon dioxide depleted gas is either vented or directed to a subsequent apparatus 10′ for further similar treatment as described above.

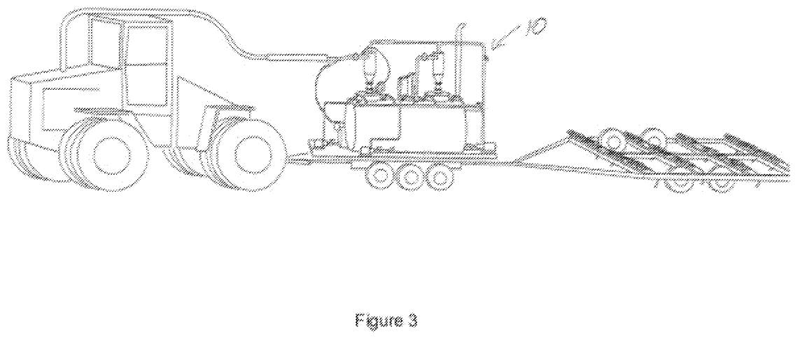

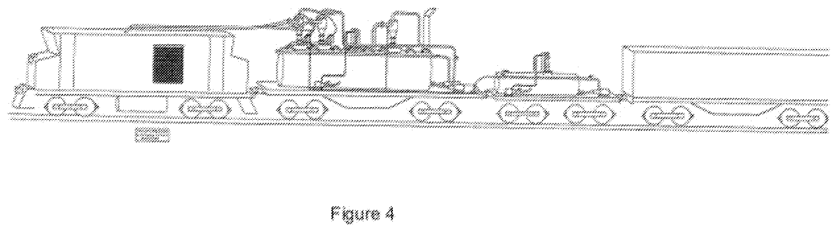

The apparatus 10 as described above may be coupled with a diesel engine used for several different applications. For example, the apparatus 10 may be conveniently mounted on a trailer in longitudinal alignment with an agricultural vehicle, such as a tractor, as shown in FIG. 3, or mounted in a consist coupled in longitudinal alignment with a diesel electric locomotive in rail applications, as shown in FIG. 4.

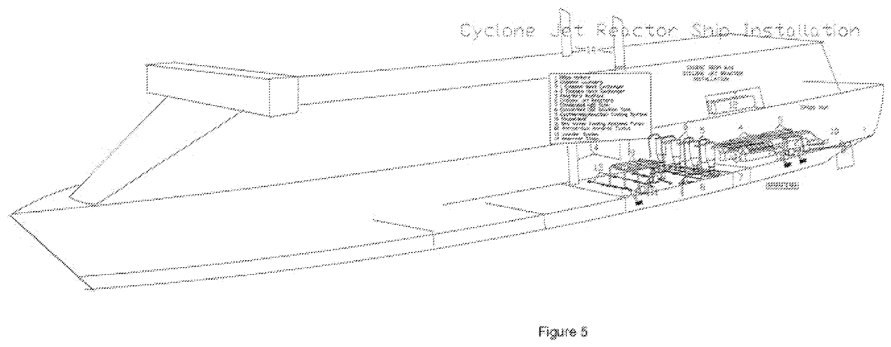

Alternatively, the apparatus 10 may be conveniently mounted proximal to a diesel engine. FIG. 5 depicts the apparatus 10 as described herein mounted proximal to one or more diesel engines used in a marine vessel. In another embodiment, the apparatus 10 may also be mounted behind the cab of a heavy duty road haulage vehicle proximal to the diesel engine in the traction unit.

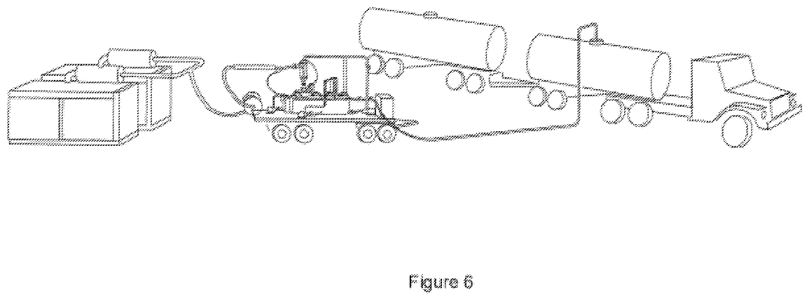

As shown in FIG. 6, the apparatus 10 may be conveniently mounted, optionally on a trailer, for treatment of diesel engine emissions from a diesel engine used in various applications such as power generation, brewing or wine production, drilling and mining applications. Alternatively, it is envisaged that the apparatus 10 as described herein may be suitably adapted and used as an atmosphere purification system, wherein polluted air is drawn into the intake manifold 14 of said apparatus 10 and treated as described herein.

In other embodiments, the apparatus 10 may be used to treat large volumes of pipeline gas containing carbon dioxide.

As will be evident from the foregoing description, the method and apparatus described herein facilitates a reduction of greenhouse gas emissions (i.e., carbon dioxide) of diesel engines.

A financial instrument tradable under a greenhouse gas Emissions Trading Scheme (ETS) may be created by integrating a diesel emissions treatment apparatus with a diesel engine, in a manner whereby the method described herein may be readily employed. The instrument may be, for example, one of either a carbon credit, carbon offset or renewable energy certificate. Generally, such instruments are tradable on a market that is arranged to discourage greenhouse gas emissions through a cap and trade approach, in which total emissions are ‘capped’, permits are allocated up to the cap, and trading is allowed to let the market find the cheapest way to meet any necessary emission reductions. The Kyoto Protocol and the European Union ETS are both based on this approach.

One example of how credits may be generated by using said apparatus is described as follows. A person who wishes to get credits from a Clean Development Mechanisms (CDM) project, under the European ETS, contributes to integration of said apparatus with diesel engine vehicles. Credits (or Certified Emission Reduction Units where each unit is equivalent to the reduction of one metric tonne of CO₂ or its equivalent) may then be issued to the person. The number of CERs issued is based on the monitored difference between the baseline and the actual emissions. It is expected by the applicant that offsets or credits of a similar nature to CERs will be available to persons investing in low carbon emission heavy vehicle transportation, and these could be similarly generated.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

For example, dilute sodium hydroxide solution may be used as an alternative to aqueous ammonia solution to convert carbon dioxide in said emissions to sodium carbonate. When the solution in the launder reservoir becomes saturated in sodium carbonate, said solution may be discharged and used glass manufacture, dry powder detergents, metallurgical processes and so forth.

Moreover, in some embodiments, the intake manifold 14 may include one or more venturi tubes integrated with the inlet 18 of the intake manifold 14 in an arrangement whereby the diesel engine emissions are delivered under increased pressure into the intake manifold 14. Said emissions are pre-conditioned by mixing with the ammonia gas stream delivered via inlet 26 and by return vapour via inlet 28. In particular, the return vapour is highly humidified by water vapour. Mixing the diesel engine emissions with the highly humidified return vapour commences the acid-base reaction between carbon dioxide in said emissions and ammonia in the return vapour. The heat generated from this exothermic reaction causes the expanding gases to increase their flow velocity, thereby increasing collisions between the gas particles and particulates in the emissions in the intake manifold. In this way, said emissions may be better conditioned before reporting to the conditioning chamber 30. The inventor opines that this early exothermic reaction assists in the emulsion of particulates contained in the diesel emissions and therefore their removal.

In the claims which follow and in the preceding description except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of treating diesel exhaust emissions, the method comprising:
a) contacting an ammonia gas stream with a diesel exhaust emissions stream to produce a gas mixture;
b) conditioning the gas mixture in a first reactor;
c) contacting the conditioned gas mixture with a first stream of aqueous ammonia solution in a first gas-liquid contact zone of the first reactor to produce a gas-liquid mixture;
d) passing the gas-liquid mixture through a static mixer; and
e) contacting the gas-liquid mixture from step d) with a second stream of aqueous ammonia solution in a second gas-liquid contact zone of the first reactor.

2. The method of claim 1 further comprising:
a) separating the resulting mixture from step e) by gravity, collecting liquid from said mixture in a launder reservoir and venting a carbon dioxide-depleted gas mixture.

3. The method of claim 2, wherein the method comprises circulating the carbon dioxide-depleted gas mixture to a second reactor and repeating steps b) to e) prior to venting said gas mixture.

4. The method of claim 1, wherein prior to step e), the method comprises agitating the gas-liquid mixture after it has passed through the static mixer.

5. The method according to claim 2, wherein the launder reservoir contains aqueous ammonia solution.

6. The method according to claim 2, wherein the method further comprises circulating first and second aqueous ammonia solutions, respectively, from the launder reservoir to the first and second gas-liquid contact zones of the first reactor.

7. The method according to claim 2, wherein the contents of the launder reservoir are maintained below 38° C.

8. The method according to claim 1, wherein conditioning the gas mixture comprises inducing high energy flow in the gas mixture and passing the gas mixture through a cyclone chamber in the first reactor in an arrangement to increase gas-solid collisions and deplete the gas mixture of particulate material, NOₓ or SOₓ.

9. The method according to claim 1, wherein passing said gas-liquid mixture through the static mixer causes the pressure of the gas-liquid mixture to be 55-60 psi.

10. The method according to claim 1, wherein the diesel exhaust emissions stream is passed through a heat exchanger before contacting said stream with the ammonia gas stream.

11. An apparatus for treating diesel exhaust emissions, the apparatus comprising:
a) a launder reservoir containing aqueous ammonia solution;
b) an intake manifold in fluid communication with a diesel engine exhaust outlet, wherein the intake manifold is provided with an inlet for ingress of an ammonia gas stream in an arrangement whereby, in use, the ammonia gas stream mixes with the diesel exhaust emissions to produce a gas mixture;
c) a conditioning chamber in fluid communication with the intake manifold to receive the gas mixture therefrom, wherein the conditioning chamber is configured to pass the gas mixture to a first gas-liquid contact zone whereby the gas mixture is reacted with a first stream of aqueous ammonia delivered via a first conduit in fluid communication with the launder reservoir and a nozzle, thereby producing a gas-liquid mixture in the first gas-liquid contact zone;
d) a static mixer in fluid communication with the first gas-liquid contact zone, and interposed between the first gas-liquid contact zone and a second gas-liquid contact zone;
e) the second gas-liquid contact zone being provided with a spray head configured to spray a second stream of aqueous ammonia solution therein, wherein said second stream is delivered to the spray head via a second conduit arranged in fluid communication with the launder reservoir, whereby in use, the gas-liquid mixture in the second gas-liquid contact zone separates by gravity, with liquid collecting in the launder reservoir and carbon dioxide-depleted gas mixture being vented therefrom.

12. The apparatus according to claim 11, wherein the conditioning chamber is provided with a cyclone chamber configured in use to induce high energy flow in the gas mixture.

13. The apparatus according to claim 11, wherein the nozzle comprises a jet nozzle or a venturi tube.

14. The apparatus according to claim 11, wherein the nozzle is disposed in concentric alignment with a central longitudinal axis of the cyclone chamber.

15. The apparatus according to claim 11, wherein the static mixer causes the pressure of the gas-liquid mixture to be 50-60 psi.

16. The apparatus according to claim 11, wherein the second gas-liquid contact zone comprises a cylindrical skirt having a lower end thereof immersed in the launder reservoir.

17. The apparatus according to claim 16, wherein the spray head may be a plurality of spray heads spaced equidistantly around and proximal to an inner surface the cylindrical skirt.

18. The apparatus according to claim 11, wherein the static mixer comprises an impellor is-disposed in an upper portion of the second gas-liquid contact zone.

19. The apparatus according to claim 11, wherein the launder reservoir is provided with means to scavenge and remove sludge therefrom.

20. The apparatus according to claim 11, wherein the launder reservoir is provided with means to vent a head space thereof.

21. The apparatus according to claim 11, wherein the apparatus is arranged in fluid communication with a heat exchanger in an arrangement whereby the heat exchanger is disposed between the diesel engine exhaust outlet and the intake manifold of the apparatus.

22. A vehicle having a diesel engine with an exhaust outlet coupled to an apparatus as defined in claim 11.

23. The vehicle according to claim 22, wherein the apparatus is mounted on a trailer in longitudinal alignment with the vehicle.

24. A method of creating a financial instrument tradable under a greenhouse gas Emissions Trading Scheme (ETS), the method comprising the step of exploiting the method for treating diesel exhaust emissions as defined in claim 1.

25. The method according to claim 24, wherein the financial instrument comprises a carbon credit, a carbon offset or a renewable energy certificate.
